(19) United States
(12) Patent Application Publication
(10) Pub. No.: US 2007/0265024 A1
(43) Pub. Date: Nov. 15, 2007

(54) METHOD AND SYSTEM FOR ACCELERATING ACCESS TO A CONTENT FROM A MOBILE TERMINAL

(75) Inventor: Francois VINCENT, CLAMART (FR)

Correspondence Address: PERMAN & GREEN, 425 POST ROAD, FAIRFIELD, CT, 06824, US

(73) Assignee: SOCIETE FRANCAISE DU RADIOTELEPHONE, Paris (FR)

(21) Appl. No.: 11/740,963

(22) Filed: Apr. 27, 2007

(30) Foreign Application Priority Data
Apr. 27, 2006 (FR) 06 03773

(51) Int. Cl. H04Q 7/20

(52) U.S. Cl. 455/466

(57) ABSTRACT

System for accelerating access to predetermined data of multimedia content or access to a value-added service, from a mobile wireless telephone communications terminal. The mobile terminal communicates with an interactive server providing the content. A wireless telephone network includes a unidirectional broadcasting centre of predetermined data from the interactive server to the mobile terminal. The predetermined data transmitted contains an identification characteristic identifiable by the mobile terminal. The mobile terminal identifies the predetermined data transmitted by the broadcast centre, saves the predetermined data, reads information representing the identification characteristic of the predetermined data saved by the mass memory means and, and authorizes or does not authorize access by the direct access key to these data.

### TECHNICAL AREA OF THE INVENTION

The disclosed embodiments pertain to the area of telecommunications applied to the access, by mobile equipment, to a multimedia content and/or a value-added service.

More particularly, the invention relates to a method for accelerating access to predetermined data consisting either of a multimedia content or of access to a value-added service, from a mobile wireless communications terminal using the infrastructure of a wireless telephone cell network, and to a system for implementing this method.

### TECHNOLOGICAL BACKGROUND OF THE INVENTION

Recent developments in technologies for wireless communication terminals, called mobile terminals e.g. mobile telephones, enable users to access a multimedia content e.g. documents circulating via wireless networks, from their mobile telephone. Said mobile phone relies on a known infrastructure of a wireless telephone cell network compatible with technology such as GSM (for Global System for Mobile communications), GPRS (for General Packet Radio Service), UMTS (for Universal Mobile Telecommunications System), OFDM (for Orthogonal Frequency Division Multiplexing), HSDPA (for High Speed Downlink Package Access), FOMA (for Freedom of Mobile Multimedia Access), CDMA (for Code Division Multiplex Access) or similar.

To access documents circulating via wireless networks, the wireless communication terminals are equipped with modules and/or specific applications, e.g. modules and/or software applications compatible with so-called WAP technology (for Wireless Application Protocol), a universal protocol. This protocol defines the manner in which mobile terminals can access a value-added service and/or a multimedia content, e.g. an Internet service, or an information page called a WAP page provided by a provider of the value-added and/or multimedia content, e.g. provided by an Internet access provider. In addition, WAP technology also defines the manner in which documents must be structured using a language such as WML (for Wireless Markup Language).

A connection made using the universal protocol, called a WAP connection, suffers a considerable handicap however due to the time required to set up this connection. The connection time for users, from their mobile equipment, to access a value-added service and/or a multimedia content, for example to launch WAP navigation, can take from thirty seconds up to one minute. This period is considered to be excessively long by a high number of users. Aside from the tiresome waiting involved, the impossible immediate access to a multimedia content, for example to the first home pages of the portal of the user's Internet access provider, makes WAP navigation unsuitable for the specific needs of a user who inter alia is in a hurry.

In known manner, a first approach to improve the launch performance of a WAP navigation consists of limiting the volume of data to be transmitted by the content provider to the user's mobile terminal. This inevitably causes notable downsizing of the content provided to the user, which is unsatisfactory. By way of illustration, the first pages of the portal of the user's Internet access provider give so little relevant information that a proiri they cannot meet the needs, even the most routine needs, of users. For example, the first portal pages of the Internet access provider do not contain any links to weather pages. As a result, this first approach is counter-productive since it goes against technical progress which tends to offer increasingly voluminous WAP pages for example to users of the multimedia content and/or value-added service.

A second known approach to improve the launch performance of a WAP navigation consists of compressing the content, so as to reduce the volume of data to be transmitted by the content provider to the user's mobile terminal. However this solution does not give satisfaction for several reasons. First, it requires lengthy and costly developments of specific layers (applications) which must subsequently be installed both in the network equipment and in the mobile terminals of users. Then, execution of the successive compression and decompression steps is time-consuming so that the expected performance gains on launch of WAP navigation become arbitrary. In addition, the execution of these steps wastes the limited energy resources of the mobile terminals. Finally, the compression of data naturally has limits. This approach therefore rapidly arrives at saturation subsequent to technical progress which tends for example to offer users of the multimedia content and/or value-added service increasingly voluminous WAP pages.

These first two known approaches are significantly limited in scope since they only act on the transmission phase of the content, whereas most of the access time to this content is consumed by setting up the link on the different layers of the protocol, in particular for subscription to the data transmission service, opening of the PDP session or context (Packet Data Protocol context), and negotiation of the conveying channel for the content.

A third known solution for improving WAP navigation launch performance consists of solving this problem globally by modifying the wireless telephone networks. This entails increasing a bandwidth of the wireless telephone networks and hence making it possible to increase the data transmission rate between the content (or service) provider and the user's mobile terminal. Spectacular progress in this respect can be illustrated by the recent development of the UMTS network, which offers an increased bandwidth compared to the GSM network. For example, the rate of the so-called SMS-CB channel (for Short Message Service Cell Broadcast) via the UMTS network towards a UMTS-compatible mobile terminal, can reach up to 32 Kbits/second, while the rate of this same SMS-CB channel via the GSM network towards a GSM-compatible mobile terminal is restricted to only 1 Kbits/second.

A fourth known solution consists of pre-subscribing the cell network subscribers to the data transmission service simultaneously with subscription to the basic services. This solution nonetheless has the drawback of entering client data into the network, for clients who do not use or only scarcely use this service, thereby monopolizing costly network resources.

However, even for the UMTS network, the connection time to a WAP service takes approximately 10 to 20 seconds, which is perceived to be very long for a user. The extraordinary increase in pass band rate offered by the UMTS network has been followed by a considerable enrichment of the multimedia content offered by a content provider on a mobile terminal, canceling out the gains achieved in WAP navigation launch performance. For example, the first portal pages of the Internet access provider now give users much richer information with photos for example, but they remain little consulted by users on account of the connection time considered to be excessive.

Another problem related to content volume lies in the parallel use of several networks, e.g. UMTS and GSM, offering different rates via their respective bandwidths. The land coverage of the UMTS network at the present time is smaller than that of the GSM network. Consequently, in relation to users' geographical position and to availability in this area of one or more networks, UMTS subscribers for example to a content and/or value-added service, must be able to switch over (or be switched over by the service and/or content provider in a manner transparent to the user), from one network to the other (from UMTS to GSM or vice versa) whilst maintaining the possibility for example to launch their WAP navigation from the first home page of the same portal of the same Internet access provider. In other words, it cannot be contemplated by an Internet access provider to produce WAP home pages of different volume in relation to the network used by its subscribers for WAP navigation, e.g. GSM or UMTS. Therefore the challenge of reducing the waiting time perceived by users to set up a WAP connection, for example with the first page of the WAP portal of the internet access provider, irrespective of the wireless telephone network used by a subscriber for this connection, fully remains.

### GENERAL DESCRIPTION OF THE INVENTION

The subject of the disclosed embodiments is therefore to eliminate one or more disadvantages of the prior art by proposing a system to accelerate access to predetermined data forming either a multimedia content or access to a value-added service, from a wireless communication mobile terminal using the infrastructure of a wireless telephone cell network.

For this purpose, the invention concerns a system for accelerating access to predetermined data forming either a multimedia content or access to a value-added service, comprising at least one terminal for wireless cell telephone communication, called a mobile terminal, containing at least one essentially electronic item with microcircuit and memory, and at least one interactive interface comprising at least one screen, at least one keypad, at least one key and/or at least one tactile area of the terminal screen, called a direct access key, enabling direct access to the multimedia content and/or value-added service, the mobile terminal being able to communicate, within a wireless telephone network identifiable by means of the network, with at least one interactive server providing the multimedia content and/or value-added service, called an interactive server, the transmitting and receiving of data between the mobile terminal and the interactive server being two-way i.e. from the mobile terminal towards the interactive server and vice versa by means of a processing node, characterized in that the wireless telephone network comprises a unidirectional broadcast centre broadcasting predetermined data from the interactive server towards the mobile terminal or a plurality of mobile terminals, via a unidirectional channel common to all the mobile terminals, in that the predetermined data transmitted by the unidirectional broadcast centre contain at least one identification characteristic identifiable by means of the mobile terminal, and in that the mobile terminal comprises:
identification means to identify the predetermined data transmitted by the unidirectional broadcast centre via the unidirectional channel common to all the mobile terminals,
mass memory means to save the predetermined data identified by the identification means,
authorization means to read data representing the identification characteristic of the predetermined data saved by the mass memory means and, in relation to this data, to allow or prohibit access by the direct access key to at least part of this predetermined data.

According to another particular aspect, the broadcast programming of predetermined data is managed in accordance with at least one broadcasting rule predetermined by the unidirectional broadcast centre or by the interactive server.

According to another particular aspect, the predetermined data are periodically updated by the interactive server, and the unidirectional broadcast centre broadcasts these updated predetermined data at the time interval predefined since the last update.

According to another particular aspect, the unidirectional broadcast centre manages a repeat broadcast of identical predetermined data according to at least one predefined repeat rule.

According to another particular aspect, the predetermined data transmitted by the unidirectional broadcast centre, via the unidirectional channel common to all the mobile terminals, are identifiable by the identification means of the mobile terminal using one or more identification characteristics chosen from among the following parameters and/or the result of a function using these parameters: (a) broadcasting timestamp of the predetermined data transmitted by the unidirectional broadcast centre; (b) content of the predetermined data transmitted by the unidirectional broadcast centre; (c) content version of the predetermined data transmitted by the unidirectional broadcast centre; (d) cell number of the wireless telephone network; (e) identifier of the mobile terminal in the wireless telephone network.

According to another particular aspect, at least part of the identification characteristics of the predetermined data is transmitted separately, via the unidirectional channel common to all the mobile terminals, by the unidirectional broadcast centre prior to the broadcasting of the predetermined data via this same unidirectional channel.

According to another particular aspect, the wireless telephone network comprises an input server installed downstream of the interactive server and upstream of the unidirectional broadcast centre with respect to the direction of transmission of the predetermined data, from the interactive server towards the mobile terminal, and the predetermined data broadcast by the unidirectional broadcast centre are formed of a plurality of messages of predefined volume, obtained during prior segmenting of the predetermined data of the interactive server by the input server in accordance with at least one predefined segmenting rule.

According to another particular aspect, the identification means of the mobile terminal maintain a unidirectional connection session permanently open from the input server to the mobile terminal, via the unidirectional channel common to all the mobile terminals.

According to another particular aspect, the mobile terminal comprises management means to send a request to the wireless telephone network to set up a new two-way connection from the mobile terminal to the interactive server using the processing node, this request being sent simultaneously with display on the mobile terminal screen of the predetermined data saved by the mass memory means, when pressing the direct access key of the mobile terminal.

According to another particular aspect, the wireless telephone network and the mobile terminal are compatible with GSM technology and/or UMTS technology.

According to another particular aspect, the predetermined data comprise at least one home page to a multimedia portal of WAP type managed by the interactive server.

To eliminate one or more disadvantages of the prior art, the invention also sets out to define a method for accelerating access to predetermined data, consisting either of a multimedia content or access to a value-added service, from a mobile communications terminal using an infrastructure of a wireless telephone cell network.

For this purpose, the invention concerns a method for accelerating access to predetermined data forming either a multimedia content or access to a value-added service, implemented by the system of the invention,

characterized in that it comprises:
a communication step of the interactive server with the wireless telephone network via at least one unidirectional broadcast centre to broadcast, via a unidirectional channel common to all the mobile terminals, the predetermined data of the interactive server to the mobile terminal or a plurality of mobile terminals, this predetermined data comprising at least one identification characteristic identifiable by means of the mobile terminal,
an identification step by identification means of the mobile terminal to identify the predetermined data transmitted by the unidirectional broadcast centre via the unidirectional channel common to all the mobile terminals,
a saving step by mass memory means of the mobile terminal to save the predetermined data identified by the identification means of the mobile terminal,
an authorization step by authorization means of the mobile terminal to read information representing the identification characteristic of the predetermined data saved by the mass memory means of the mobile terminal and, in relation to this information, to authorize or not authorize use of at least part of this predetermined data by using the direct access key.

According to another particular aspect, the method comprises a programming step to program broadcasting of the predetermined data, managed by the unidirectional broadcast centre or by the interactive server in accordance with at least one predefined broadcasting rule.

According to another particular aspect, the method comprises:
a periodical updating step of the predetermined data by the interactive server, and
a broadcasting step of this updated predetermined data, by the unidirectional broadcast centre at the time interval predefined since the last broadcasting.

According to another particular aspect, the method comprises a repeat broadcast step by the unidirectional broadcast centre of identical predetermined data in accordance with at least one predefined repeat rule.

According to another particular aspect of the method, the broadcasting step of the predetermined data by the unidirectional broadcast centre is preceded by a prior, separate broadcasting step by the unidirectional broadcast centre, via the channel common to all the mobile terminals, of at least part of the identification characteristics of the predetermined data.

According to another particular aspect of the method, the broadcasting step of the predetermined data by the unidirectional broadcast centre, via the unidirectional channel common to all the mobile terminals, is preceded by a prior segmenting step of the predetermined data into a plurality of messages of predefined volume by an input server installed downstream of the interactive server and upstream of the unidirectional broadcast centre with respect to the direction of transmission of the predetermined data from the interactive server to the mobile terminal, this segmenting being conducted by the input server in accordance with at least one predefined segmenting rule.

According to another particular aspect, the method comprises a permanent opening step, by the identification means of the mobile terminal, of a unidirectional connection to the input server from the mobile terminal, via the unidirectional channel common to all the mobile terminals.

According to another particular aspect, the method comprises a request-sending step by management means of the mobile terminal to the wireless telephone network, to set up a new two-way connection from the mobile terminal to the interactive server using the processing node of the wireless telephone network, this request-sending step being conducted simultaneously with a display step of the predetermined data saved by the mass memory means of the mobile terminal on the screen of the mobile terminal, these two steps being triggered by actuation of the direct access key on the mobile terminal.

According to another particular aspect of the method, the wireless telephone network through which the predetermined data of the interactive server are transmitted, and the mobile terminal receiving this data, are compatible with GSM technology and/or UMTS technology.

According to another particular aspect of the method, the predetermined data comprise at least one home page to a multimedia portal of WAP type managed by the interactive server.

The invention, with its characteristics and advantages, will become more clearly apparent on reading the description made with reference to the appended drawings in which:

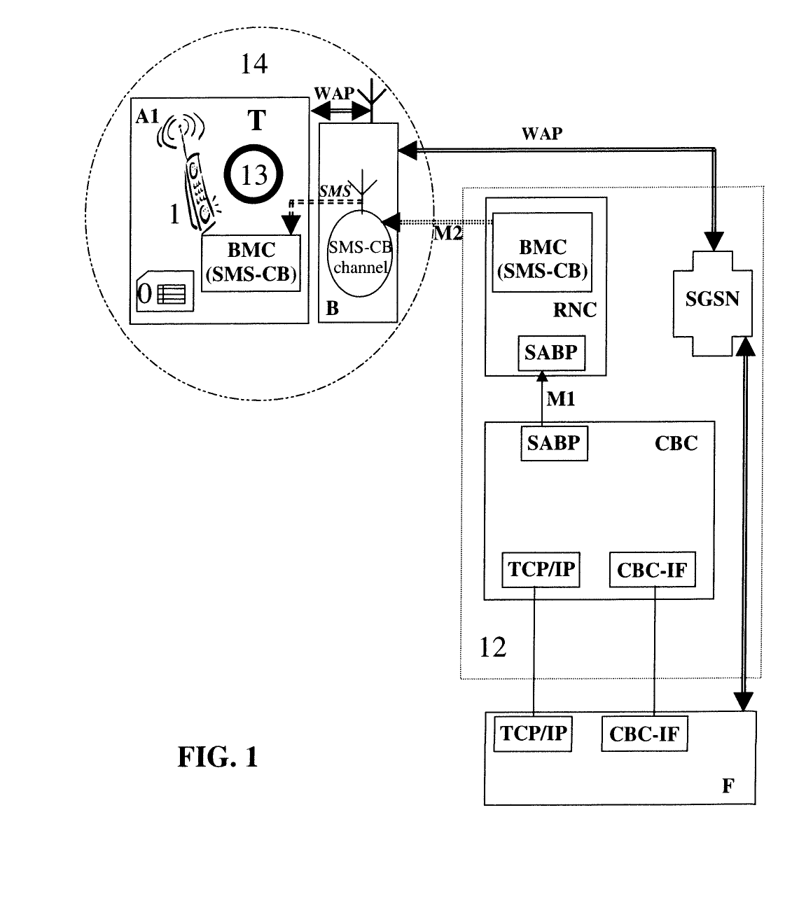

FIG. 1 is a schematic of one embodiment of the system according to the invention,

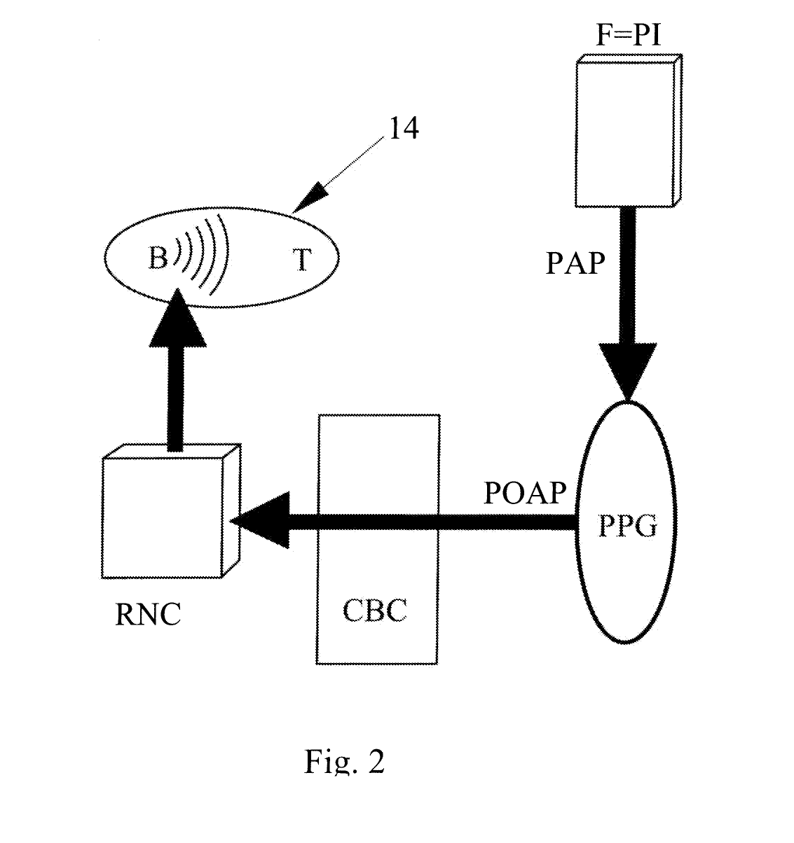

FIG. 2 is a schematic of another embodiment of part of the system according to the invention.

### DESCRIPTION OF PREFERRED EMBODIMENTS OF THE INVENTION

Such as schematically illustrated in most simplified manner FIGS. 1 and 2, the system of the invention allows accelerated access to predetermined data forming either a multimedia content or access to a value-added service, and comprises at least one wireless telephone communication cell terminal, called a mobile terminal (T), containing at least one interactive interface, in the form of a telephone handset (1) for example provided with a keypad and screen, and with at least one essentially electronic item for example having several layers with a microcircuit and a memory, namely a so-called SIM card (0) (for Subscriber Identity Module). In known manner, this card contains the identifier of the subscriber using the mobile terminal (T), called IMSI (for International Mobile Subscriber Identity), and the main characteristics of the subscription. The mobile terminal (T) will be identified by the identity of the mobile terminal, called IMEI (for International Mobile Equipment Identity).

The system uses a known infrastructure of a wireless telephone cell network, e.g. of GSM or UMTS type, and whose core is referenced (12) in FIG. 1. With reference for example to a UMTS wireless telephone network, the telephone handset (1) is provided in known manner with an antenna (A1) of UMTS type allowing transmission of data towards receivers or receiving of data from the transmitter of the base station (Node B) forming a cell (14). The latter are controlled in known manner by a Radio Network Controller <<RNC>>. The remainder of the network controlling the transfer of data and/or identification of the mobile terminal (T) is not shown FIG. 1 but is used in known manner.

In known manner the mobile terminal, identifiable by the network means, is able to communicate within a wireless telephone network with at least one interactive server providing the multimedia content and/or value-added service, called the interactive server (F). In known manner, the transmitting and receiving of data between the mobile terminal (T) and the interactive server (F) is conducted two-way fashion i.e. from the mobile terminal to the interactive server and vice versa via a dedicated data transmission channel which cannot be received by other terminals in radio link with the cell (14).

With reference to the UMTS wireless telephone network, the two-way transmitting and receiving of data between the mobile terminal (T) and the interactive server (F) is conducted for example using a data processing node, called a processing node. This may be a processing node of SGSN type (for Serving GPRS Support Node) which can for example ensure control of the connection to the data network and management of mobility within the network, whilst ensuring the routing of data flows between the mobile terminal (T) and the interactive server (F). Therefore a subscriber having the mobile terminal (T) can access the multimedia content and/or value-added service provided by the interactive server (F). This may entail access to a home page of a multimedia portal of WAP type for example managed and/or hosted by the interactive server (F) belonging to the Internet access provider of the subscriber.

To facilitate this subscriber access to the multimedia portal, the mobile terminal (T), and in particular the telephone handset (1), may comprise at least one direct means of access to the multimedia content and/or value-added service. This may be a key on the keypad of the mobile terminal (T) for example, called a direct access key (13), and/or a tactile area on the terminal screen giving direct access to the multimedia content and/or value-added service and/or an access via a scroll menu. Therefore, by pressing on this direct access key (13) or by touching the tactile area of the mobile terminal (T), the subscriber sets up a two-way wireless connection for example via a two-way data transmission and receiving channel particular to the mobile terminal (T) and to the interactive server (F), called a WAP connection, which generates the transfer of data from the radio network controller (RNC) to the interactive server (F) by means of the processing node SGSN. This routing of the data is schematically shown by the double line in FIG. 1.

The WAP connection in a wireless telephone network using a SGSN processing node, proceeds at the current time in at least four known steps, for example:
an attachment step attaching the mobile terminal (T) to the base station (B) forming the cell (14) of the wireless telephone network, and in the core of the network:
a negotiation step to negotiate the service and/or transmission quality;
a step setting up a link between the core of the wireless telephone network and the wireless part of the telephone network;
a routing step to rout data packets over the entire length of the network between the interactive server (F), e.g. WAP, and the mobile terminal (T).

Each of these steps requires a certain time for its execution: the WAP connection in the wireless telephone network using the SGSN processing node requires a waiting time of a few dozen seconds, e.g. approximately 10 s to 20 s for the UMTS network.

To reduce this time, the attachment step of the mobile terminal (T) to a cell of the wireless telephone network and to the core of the network is conducted simultaneously with an attachment step to the data transmission service at the SGSN processing node, to enter the subscriber identifiers for example. This has a significant impact on the total number of entered subscribers in the SGSN processing node, and on the cost associated with licenses granted for the data transmission service whether or not it is used. This embodiment requires the implementation of detachment means (e.g. at the wireless telephone network level or the mobile terminal) which terminates the entry of the subscriber with the SGSN processing node after a predetermined period of inactivity, for example after extended non-exchanging (e.g. for 3 hours) between the mobile terminal (T) and the interactive server (F).

At all events, the three last steps necessary for loading data representing the access pages to WAP services, remain indispensable for all connections to the interactive server (F) from the mobile terminal (T).

In other words, an initial entry of the subscriber identifiers with the SGSN processing node, for example at the time of subscription to basic services (voice, SMS (Short Message Service), etc.) does not ensure a definite reduction in the waiting time for the subscriber when launching WAP connections.

It has been observed that most subscribers wishing to access a multimedia content and/or value-added service provided by the interactive server (F), after launching a WAP connection using the direct access key (13), start with the first home page of the WAP portal managed and/or hosted by the subscriber's Internet access provider. This first page is updated by the Internet access provider several times a day, but remains unchanged over predetermined periods e.g. around 1 to 2 hours. The first home page of the WAP portal has at least one link application allowing access to another multimedia content e.g. to other WAP pages called secondary WAP pages. These are WAP pages for example with other link applications giving access to yet another multimedia content e.g. the day's weather forecast, traffic news, headline news, results of sports events etc. The number of these other WAP pages (and hence of the link applications on the first home page of the WAP portal) is generally limited to one dozen for example. These secondary WAP pages may or may not be managed and/or hosted by the subscriber's Internet access provider. In one variant of the invention, these home pages provide at least part of the multimedia content and/or value-added service sought by the subscriber, for example the numbers to be called for emergency situations (fire brigade, police, emergency medical unit, etc.). In another variant of the invention, the two arborescence levels of the WAP pages (home page of the WAP portal forming the first level, secondary WAP pages forming the second level) do not in the strict sense provide the multimedia content, but provide guidance for the subscriber in the page environment, directing the subscriber to the desired multimedia content and/or value-added service. It will be noted, that in order to be able to pass through these two WAP page levels, for example the two first home pages of the WAP portal, the subscriber must wait between 30 s and 60 s, taking into account connection, transmission and navigation times (activation of link applications).

To reduce this waiting time for the subscriber, the system of the invention advantageously proposes pre-loading predetermined data forming for example the first home pages of a WAP portal, derived from the interactive server and sent to the mobile terminal, to the memory of the mobile terminal mobile (T), while allowing the terminal's operating system to access this predetermined data by means of the direct access key (13) for example.

For this purpose, the wireless telephone network comprises a management centre for the unidirectional broadcasting of predetermined data from the interactive server (F) to the mobile terminal (T) or a plurality of mobile terminals, via a unidirectional channel common to all the mobile terminals. This management centre for the unidirectional broadcasting of predetermined data may for example be a <<CBC>> centre (for Cell Broadcast Centre) cooperating with the means of the wireless telephone network and dedicated to managing the transfer of predetermined data sent from the interactive server (F) to at least one cell (14) in charge of broadcasting to the mobile terminal (T) or a group of mobile terminals.

Also, the predetermined data transmitted by the CBC centre contain at least one identification characteristic identifiable by means of the mobile terminal. In this respect it is to be noted that the predetermined data transmitted by the CBC centre, via the unidirectional channel common to all the mobile terminals, are identifiable by the identification means of the mobile terminal using one or more identification characteristics chosen from among the following parameters and/or the result of a function using these parameters: (a) broadcast timestamp of the predetermined data by the unidirectional broadcast centre; (b) content of the predetermined data transmitted by the unidirectional broadcast centre; (c) content version of the predetermined data transmitted by the unidirectional broadcast centre; (d) cell number of the wireless telephone network; (e) identifier of the mobile terminal in the wireless telephone network.

Also, the mobile terminal advantageously comprises:
identification means to identify the predetermined data transmitted by the unidirectional broadcast centre via the unidirectional channel common to all the mobile terminals. This enables the terminal mobile (T) not to re-listen to or re-save messages whose status of the identification characteristic (e.g. the content version) is identical to that of the messages already saved, thereby saving energy, memory etc. Another example is that of a mobile terminal (T) moving from one cell of the wireless telephone network to another, which will not seek to save a message having an identical identifier, with the exception of the number of the transmitting cell. Therefore the operating system of each terminal will take the decision, after receipt and analysis of these identifiers, whether or not to listen to and save this predetermined data.
mass memory means to save the predetermined data identified by the identification means,
authorization means to read the information representing the identification characteristic of the predetermined data saved by the mass memory means and, in relation to this information, to authorize or not authorize access by the direct access key to at least part of this predetermined data.

In another embodiment of the system according to the invention, the mobile terminal (T) comprises management means to send a request to the wireless telephone network to set up a new two-way connection from the mobile terminal (T) to the interactive server (F) using the processing node, this request being sent simultaneously with display of the predetermined data on the screen of the mobile terminal by means of the direct access key (13) on the mobile terminal (T).

By way of illustration, it is to be noted for example that for 15 WAP pages of 20 Koctets (Ko), each forming the two arborescence levels of the WAP access pages of the interactive server (F) to be updated every hour, the resource needed is 2400 Kbits/hour, i.e. 0.66 Kbits/second. However, for the UMTS wireless telephone network, the base station (Node B) has a SMC-CB channel for example (Short Message Service Cell Broadcast) allowing a rate of up to 30 Kbits/second. There is therefore a sufficient rate margin to make provision not only for the unit sending of the 15 WAP pages every hour, but also for repeat strategies ensuring guaranteed receipt of these pages by the mobile terminal (T). The <<scarcely reliable>> nature of the SMS-CB channel due to the absence of acknowledgement of receipt by the mobile terminal (T) requires a repeat strategy so as to ensure availability of adequate WAP pages, and in particular of the first home page to the WAP portal. It is specified that the term <<scarcely reliable>>, used to describe the particular nature of the SMS-CB channel, does not in any way translate any technical problem related to data transmission, since from a technical viewpoint as such the SMS-CB channel is evidently fully reliable. The <scarcely reliable>> nature of the SMS-CB channel is to be understood in the meaning that the transmission of data from the interactive server (F) to the mobile terminal (T) is unidirectional. Having regard to this absence of a return channel, the mobile terminal (T) does not therefore confirm proper receipt of the data sent by the interactive server (F) either to it or to another element of the wireless telephone network. Yet, during roaming of the subscriber, its mobile terminal (T) may for example come to be located in an area in which reception of the signal by the mobile terminal via the SMS-CB channel is uncertain. The subscriber may then leave this uncertain reception area and re-enter an area of reliable reception and vice versa. Therefore, in the absence of repeat strategies to send data from the interactive server to the mobile terminal (T), the guaranteed reception thereof by the mobile terminal risks being compromised if it is sent when the subscriber is momentarily in the area in which reception of the signal by the mobile terminal via the SMS-CB channel is uncertain.

It is to be noted that the specifications of the wireless data transfer protocol, meeting OMA standards for example (for Open Mobile Alliance), called the WDP protocol (for Wireless Data Protocol), make provision for the transfer of WAP pages for example over a wide variety of carrier channels including the SMS-CB channel. Consequently, the choice of the SMS-CB channel mentioned above by way of illustration is in no way limiting.

Regarding the GSM wireless telephone network, the base station (B) has the SMS-CB channel for GSM allowing a transmission rate in the order of 1 Kbits/second. This rate is therefore not sufficient to update the two arborescence levels of the WAP pages consisting of 15 pages of 20 Ko each in the present example, and to ensure their guaranteed reception using repeat data sending strategies. However, a rate of 1 Kbits/second of the SMS-CB channel for GSM easily allows sending of the update every hour of a lesser data volume, e.g. the first home page of the WAP portal.

This is why, in another embodiment of the system according to the invention, the unidirectional broadcast centre manages a repeat broadcasting of identical predetermined data in accordance with at least one predefined repeat rule, e.g. once every hour.

This approach advantageously facilitates the broadcasting of the same data over all the cells of the wireless telephone network for example without having to identify the given mobile terminal (T). In another example, it is possible to limit the sending of data solely to those terminals present in a given cell (14) or to those terminals whose identifier (e.g. the mobile telephone number allocated to the subscriber by the manager of the wireless telephone network) comprises a predetermined number of figures etc. Evidently, the repeat rule or rules mentioned above may also take into account one or more of these parameters and/or the result of a function using these parameters. These rules are managed by the CBC centre which comprises the means enabling the operator to manage these rules.

With further reference to the above example of the UMTS wireless telephone network, the CBC centre is able to dialogue with the radio network controller (RNC) using software means and equipment implementing a standardized protocol, e.g. the <<SABP>> protocol (for Service Area Broadcast Protocol). Similarly, the radio network controller (RNC) and the mobile terminal (T) each have software means and equipment implementing at least one specific control layer at the CBC centre, e.g. the <<BMC>> layer (for Broadcast Multicast Control). These means therefore enable the CBC centre or the interactive server (F), in accordance with at least one predefined broadcasting rule, to manage programming of the broadcasting of the predetermined data.

Another example concerns the predetermined data which are updated by the interactive server (F), e.g. periodically (to replace a former version of the multimedia content by its new version for example). The means mentioned above (SABP protocol, BMC layer) enable the CBC centre to broadcast these updated predetermined data, for example at the time interval predefined since the last update, e.g. immediately after the last update of the predetermined data by the interactive server (F), and/or since the last broadcasting by the CBC centre of these updated predetermined data.

Another illustration of the functions operated by the CBC centre (and supported by the [BMC] layer) concerns the specific manner for conveying messages. For example, the CBC centre can broadcast a specific programming message indicating to the mobile terminals (T) what the interactive server (F) will subsequently broadcast. This may be the parameters already mentioned above such as summary of content, version of content, broadcasting time, time since the last update of a predetermined WAP, this WAP page being managed and/or hosted by the interactive server (F), etc.

According to another chosen embodiment of the invention, the programming message can be generated either by the CBC centre, or by the interactive server (F) (e.g. immediately after the updating of the predetermined WAP page). In this latter case, the programming message transits via the CBC centre but is not modified by it. Similarly, this programming message with the status of the identification characteristics of the predetermined data (for example the first home page of the WAP portal) may or may not be associated with each transmission of predetermined data.) In other words, the CBC centre may, for example, broadcast firstly the programming message and then only afterwards another message with the predetermined data. In another variant of the invention, the programming message and the message with the predetermined data are merged.

For a better understanding of the functioning of the system according to the invention, and in particular of the trigger mechanism for data transfer from the interactive server (F) to the mobile terminal (T) on the initiative of the interactive server (F), a configuration of the system of the invention may be cited as example which is compatible with the so-called <<WAP push>> mode, whose architecture is schematically illustrated FIG. 2. This figure shows the interactive server (F) acting as a send initiating server (F=PI) (i.e. a Push Initiator) and the mobile terminal (T) of the subscriber. Similarly, the wireless telephone network comprises an input server, e.g. a so-called <<PPG >> server (for Push Proxy Gateway). It is installed downstream of the interactive server (F=PI) and upstream of the CBC broadcast centre with respect to the direction of transmission of the predetermined data from the interactive server (F=PI) to the mobile terminal (T).

The exchange between the interactive server (F=PI) and PPG input server is made using software and equipment means implementing for example a specific <<PAP>> protocol (for Push Access Protocol). The exchange between the PPG input server and the mobile terminal is made with software and equipment means implementing another specific protocol, for example the <<POAP>> protocol (for Push Over the Air Protocol). For this purpose, the opening of a unidirectional connection session at the input server of the mobile terminal (T) is needed, via the unidirectional channel common to all the mobile terminals, e.g. SMS-CB, between the mobile terminal (T) and the input server PPG. In one embodiment of the system according to the invention, the identification means of the mobile terminal (T) maintain the unidirectional connection session permanently open. This possible permanent opening of the unidirectional connection session solely via the SMS-CB channel advantageously enables the mobile terminal (T):
to receive and/or save predetermined data derived from the interactive server when the handset is exclusively in <<idle mode>> or exclusively in <<always-on mode>>),
not to receive and/or not to save the predetermined data derived from the interactive server when the handset is in voice transmitting/receiving mode, for example during a telephone conversation of the subscriber.

In other words, the possible permanent opening of the unidirectional connection session, but solely via the SMS-CB channel, allows the receiving and/or saving of predetermined data in relation to different functioning statuses of the mobile terminal (T).

The PPG input server solves the addressing issues for the SMS-CB channel.

Similarly, the predetermined data broadcast by the CBC centre are formed of a plurality of messages of predefined volume, obtained during prior segmenting of the predetermined data of the interactive server (F) by the PPG input server in accordance with at least one predefined segmenting rule. For this purpose, the PPG input server can use the software and equipment means implementing the WDP protocol for example, which is suitable for segmenting WAP pages into short messages of SMS type (Short Message Service). Regarding the SMS-CB channel, this is used to convey these SMS messages. The size of an SMS message is limited to predetermined number of octets, e.g. a maximum of 1230 octets. Therefore the WAP pages derived from the interactive server (F) are segmented by the PPG input server into a number of corresponding SMS messages before their transfer, e.g. in packets, via the SMS-CB channel, to the mobile terminal (T).

The general functioning of the system according to the invention can be illustrated by a very simplified example given below. First the interactive server (F=PI) detects a predetermined WAP home page of the WAP portal, updated for example by the subscriber's Internet access provider. Then the interactive server (F=PI) requests the PPG input server to broadcast (and/or update) the WAP page concerned using the CBC centre and via the SMS-CB channel of the base station (B), for example in all the mobile terminals (T) of the UMTS wireless telephone network.

The input server (PPG) then communicates with the CBC centre transmitting to it a first time-stamped broadcasting order (M1), and specifying for example the number of the first order, the number of the multimedia content version, the broadcast cell (14) number, the number of pages etc. The CBC centre transmits this first broadcasting order (M1) to the radio network controller RNC. The RNC processes the order then generates a second time-stamped broadcasting order (M2) to be sent for example to all the cells concerned, this order reproducing part of the first broadcasting order e.g. the number of the first order, the number of the multimedia content version, the number of pages etc., but without keeping the cell number for example. This second order (M) is then transmitted to the base stations (B) which broadcast the predetermined data via their SMS-CB channel to all the mobile terminals for example (T).

The mobile terminals (T) are pre-programmed to listen to the messages, i.e. to receive and/or save them using mass memory means of each mobile terminal (T). Messages, e.g. of SMS type, forming the WAP page, are grouped together into a plurality of messages transmitted to a specific application, of modular architecture for example, arranged in each of the mobile terminals (T) of the UMTS wireless telephone network. For each terminal, this specific application carries out the following main tasks for example:
save the WAP page using mass memory means of the mobile terminal (T),
manage the direct access key (13) to the WAP portal to decide whether or not (for example according to the date of the last update of the saved page) to allow access to the memory or to allow navigation in the remote content,
if display of the saved page is decided, procedure for attachment of data (e.g. to the SGSN processing node) is initiated followed by opening of negotiation for quality of service using the <<PDP>> protocol for example (for Packet Data Protocol) and the setting-up of a link between the network core (12) and its wireless part (B), with a view to setting up a two-way connection at the interactive server, for example using the SGSN processing node,
during navigation in the first home page memorized by the mass memory means of the mobile terminal, access to a directly dependent page e.g. a second home page, is similarly first searched in the memory of the mobile terminal (T), and should this fail by a message sent to the server via the two-way connection.

As already mentioned above, the access to these pre-saved pages in the memory of the mobile terminal is impossible other than via the normal man-machine interface (MMI) for connection to the WAP portal, in order to pay heed, when applicable, to acts of law on the broadcasting of unsolicited messages.

In terms of advantages, the system according to the invention gives subscribers the impression of near-instant access to at least the first home page of the WAP portal, and even to the two arborescence levels of the WAP pages. This undeniably improves performance on launch of a WAP navigation, enabling the subscriber to have near-instant access to at least part of the desired content, e.g. to numbers of emergency services (without having to wait for this information during the half minute or so needed for the WAP connection, as specified above).

Another advantage provided by the system of the invention is the radical reduction in the number of persons licensed to have access to the SGSN processing node. It is effectively no longer necessary to presenter the subscribers to gain 5 seconds for example in the opening time of a WAP session.

Finally, the system of the invention is based on standard protocols thereby limiting specific developments, which in fine increases the reliability of the system of the invention making it more stable against computer bugs.

It will be evident for persons skilled in the art that the disclosed embodiments disclosed embodiments allows embodiments in numerous other specific forms without departing from the scope of application of the invention as claimed. Therefore the present embodiments are to be considered illustrative, but can be modified within the area defined by the scope of the appended claims, and the invention is not to be limited to the details set forth above.

1. System for accelerating access to predetermined data consisting either of a multimedia content, or of access to a value-added service, comprising at least one terminal of a wireless communication cell telephone network, called a mobile terminal (T), containing at least one essentially electronic item with microcircuit and memory (0) and at least one interactive interface (1) having at least one screen, at least one keypad, at least one key and/or at least one tactile area of the terminal screen, called a direct access key (13), giving direct access to the multimedia content and/or value-added service, the mobile terminal (T) being able to communicate in a wireless telephone network identifiable by means of the network, with at least one interactive server providing the multimedia content and/or value-added service, called an interactive server (F), the transmitting and receiving of data between the mobile terminal (T) and the interactive server (F) being conducted two-way fashion from the mobile terminal (T) to the interactive server (F) and vice versa using at least one processing node (SGSN), characterized in that the wireless telephone network comprises a unidirectional broadcast centre (CBC) broadcasting predetermined data from the interactive server (F) to the mobile terminal (T) or a plurality of mobile terminals (T), via a unidirectional channel (SMS-CB) common to all the mobile terminals (T), in that the predetermined data transmitted by the unidirectional broadcast centre (CBC) contain at least one identification characteristic identifiable by means of the mobile terminal (T), and in that the mobile terminal (T) comprises:
identification means to identify the predetermined data transmitted by the unidirectional broadcast centre (CBC) via the unidirectional channel (SMS-CB) common to all the mobile terminals (T),
mass memory means to save the predetermined data identified by the identification means,
authorization means to read information representing the identification characteristic of the predetermined data saved by the mass memory means and, in relation to this information, to authorize or not authorize access by the direct access key (13) to at least part of these predetermined data

2. System according to claim 1, characterized in that programming of the broadcasting of the predetermined data is managed in accordance with at least one broadcasting rule predefined by the unidirectional broadcast centre (CBC) or by the interactive server (F).

3. System according to claim 2, characterized in that the predetermined data are periodically updated by the interactive server (F), and in that the unidirectional broadcast centre (CBC) broadcasts these updated predetermined data at the time interval predefined since the last update.

4. System according to claim 1, characterized in that the unidirectional broadcast centre (CBC) manages a repeat broadcast of the identical predetermined data in accordance with at least one predefined repeat rule.

5. System according to claim 1, characterized in that the predetermined data transmitted by the unidirectional broadcast centre (CBC), via the unidirectional channel (SMS-CB) common to all the mobile terminals (T), are identifiable by the identification means of the mobile terminal (T) using one or more identification characteristics chosen from among the following parameters and/or the result of a function using these parameters: (a) broadcast timestamp of the predetermined data broadcast by the unidirectional broadcast centre (CBC); (b) content of the predetermined data transmitted by the unidirectional broadcast centre (CBC); (c) content version of the predetermined data transmitted by the unidirectional broadcast centre (CBC); (d) number of the cell (14) of the wireless telephone network; (e) identifier of the mobile terminal (T) in the wireless telephone network.

6. System according to claim 1, characterized in that at least part of the identification characteristics of the predetermined data is transmitted separately, via the unidirectional channel (SMS-CB) common to all the mobile terminals (T), by the unidirectional broadcast centre (CBC) prior to the broadcasting, via this same unidirectional channel (SMS-CB), of the predetermined data.

7. System according to claim 1, characterized in that the wireless telephone network comprises an input server (PPG) installed downstream of the interactive server (F) and upstream of the unidirectional broadcast centre (CBC) with respect to the direction of transmission of the predetermined data from the interactive server (F) to the mobile terminal (T), and in that the predetermined data broadcast by the unidirectional broadcast centre (CBC) are formed of a plurality of messages of predefined volume obtained during prior segmenting of the predetermined data of the Interactive server (F) by the input server (PPG) in accordance with at least one predefined segmenting rule.

8. System according to claim 7, characterized in that the identification means of the mobile terminal (T) maintain permanently open a unidirectional connection session from the input server (PPG) to the mobile terminal (T), via the unidirectional channel (SMS-CB) common to all the mobile terminals (T).

9. System according to claim 1, characterized in that the mobile terminal (T) comprises management means to send a request to the wireless telephone network to set up a new two-way connection from the mobile terminal (T) to the interactive server (F) using the processing node (SGSN), this request being sent simultaneously with display of predetermined data saved by the mass memory means of the mobile terminal (T) on the screen of the mobile terminal (T) by means of the direct access key (13) of the mobile terminal (T).

10. System according to claim 1, characterized in that the wireless telephone network and the mobile terminal are compatible with GSM technology and/or UMTS technology.

11. System according to claim 1, characterized in that the predetermined data contain at least one home page to a multimedia portal of WAP type, managed by the interactive server (F).

12. Method for accelerating access to predetermined data consisting either of a multimedia content, or of access to a value-added service, implemented by the system according to claim 1,
characterized in that it comprises:
a communication step of the interactive server (F) with the wireless telephone network via at least one unidirectional broadcast centre (CBC) to broadcast, via a unidirectional channel (SMS-CB) common to all the mobile terminals (T), the predetermined data of the interactive server (F) to the mobile terminal (T) or a plurality of mobile terminals (T), these predetermined data containing at least one identification characteristic identifiable by means of the mobile terminal (T),
an identification step by identification means of the mobile terminal (T) to identify the predetermined data transmitted by the unidirectional broadcast centre (CBC), via the unidirectional channel (SMS-CB) common to all the mobile terminals (T),
a saving step by mass memory means of the mobile terminal (T) to save the predetermined data identified by the identification means of the mobile terminal (T),
an authorization step by authorization means of the mobile terminal (T) to read information representing the identification characteristic of the predetermined data saved by the mass memory means of the mobile terminal (T) and, in relation to this information, to authorize or not authorize, via the direct access key (13) the use of at least part of these predetermined data.

13. Method according to claim 12, characterized in that it comprises a step to program broadcasting of the predetermined data, managed by the unidirectional broadcast centre (CBC) or by the interactive server (F) in accordance with at least one predefined broadcasting rule.

14. Method according to claim 13, characterized in that it comprises:
a periodic update step of the predetermined data by the interactive server (F), and
a broadcasting step of these updated, predetermined data by the unidirectional broadcast centre (CBC) at the time interval predefined since the last broadcasting.

15. Method according to claim 12, characterized in that it comprises a broadcast repeat step by the unidirectional broadcast centre (CBC) of the identical predetermined data in accordance with at least one predefined repeat rule.

16. Method as in claim 12, characterized in that the broadcasting step of the predetermined data by the unidirectional broadcast centre (CBC) is preceded by a prior, separate broadcasting step by the unidirectional broadcast centre (CBC), via the unidirectional channel (SMS-CB) common to all the mobile terminals (T), to broadcast at least part of the identification characteristics of the predetermined data.

17. Method according to claim 12, characterized in that the broadcasting step of the predetermined data by the unidirectional broadcast centre (CBC), via the unidirectional channel (SMS-CB) common to all the mobile terminals (T), is preceded by a prior segmenting step of the predetermined data into a plurality of messages of predefined volume by an input server (PPG) installed downstream of the interactive server (F) and upstream of the unidirectional broadcast centre (CBC) with respect to the direction of transmission of the predetermined data from the interactive server (F) to the mobile terminal (T), this segmenting being conducted by the input server (PPG) in accordance with at least one predefined segmenting rule.

18. Method according to claim 17, characterized in that comprises a permanent opening step, by the identification means of the mobile terminal (T), of a unidirectional connection to the input server (PPG) from the mobile terminal (T), via the unidirectional channel (SMS-CB) common to all the mobile terminals (T).

19. Method according to claim 12, characterized in that it comprises a step to send a request by management means of the mobile terminal (T) to the wireless telephone network, to set up a new two-way connection from the mobile terminal (T) to the interactive server (F) using the processing node (SGSN) of the wireless telephone network, this request-sending step being conducted simultaneously with a display step on the screen of the mobile terminal (T), of the predetermined data saved by the mass memory means of the mobile terminal (T), these two steps being triggered by actuation of the direct access key (13) on the mobile terminal (T).

20. Method according to claim 12, characterized in that the wireless telephone network through which the predetermined data of the interactive server (F) are transmitted, and the mobile terminal (T) receiving these data, are compatible with GSM technology and/or UMTS technology.

21. Method according to claim 12, characterized in that the predetermined data comprise at least one home page to a multimedia portal of WAP type, managed by the interactive server (F).
